(19) United States
(12) Patent Application Publication
(10) Pub. No.: US 2008/0078119 A1
(43) Pub. Date: Apr. 3, 2008

(54) PLANT STARTER CELL CONTAINER ARRAY RACK

(76) Inventors: Thomas C. HANSEN, Rohnert Park, CA (US); Thomas NEMCIK, Sonoma, CA (US)

Correspondence Address: STAINBROOK & STAINBROOK, LLP, 412 AVIATION BOULEVARD, SUITE H, SANTA ROSA, CA, 95403, US

(21) Appl. No.: 11/864,351

(22) Filed: Sep. 28, 2007

Related U.S. Application Data
(60) Provisional application No. 60/827,616, filed on Sep. 29, 2006.

(51) Int. Cl. A01G 9/02

(52) U.S. Cl. 47/66.5

(57) ABSTRACT

A set of stackable plant starter cell trays in which each of the plant trays include a plurality of inwardly tapering starter cell sockets for removable insertion of plant starter cells. Each of the plant trays has upper and lower leg connection means for the removable insertion of support legs, and each of the support legs is adapted for removable insertion into one of the leg connection means.

### CROSS REFERENCES TO RELATED APPLICATIONS

The present application is based on U.S. Provisional Patent Application Ser. No. 60/827,616, filed Sep. 29, 2006 (Sep. 29, 2006).

### STATEMENT REGARDING FEDERALLY SPONSORED RESEARCH OR DEVELOPMENT

Not applicable.

### THE NAMES OR PARTIES TO A JOINT RESEARCH AGREEMENT

Not applicable.

### INCORPORATION-BY-REFERENCE OF MATERIAL SUBMITTED ON A COMPACT DISC

Not applicable.

### BACKGROUND OF THE INVENTION

1. Field of the Invention

The present invention relates to apparatus for growing and propagating plants, and more specifically to apparatus for starting plants from vegetative or woody cuttings, seed or seedlings, and still more particularly to a container array rack for plant starter cells.

2. Discussion of Related Art Including Information Disclosed Under 37 CFR §§1.97, 1.98

Racks for holding tubes are well known. Indeed, most of the art relevant to a consideration of the novelty of the present invention is not found in the botanical sciences, but in the laboratory apparatus routinely employed in biotechnology and the chemical sciences; notably, test tube racks and PCR plates, or the racks, trays, and plates adapted for use in conducting polymerase chain reactions procedures and analysis.

Notable among the more recent innovations are the apparatus shown in the following patents:

U.S. Pat. No. 7,232,038, to Whitney, teaches a test tube rack comprising a tray, a central support panel and/or lower support panel and a cover. The tray and cover are identical and interchangeable, and tapered for storage in nested stacks. Wells in the tray bottom are aligned with corresponding openings in the central support panel and corresponding holes in the lower support panel and with domes in the cover, and serve to locate and retain test tubes within the test tube rack. The cover snap-attaches to the tray with at least one molded-in tab on the tray or cover which is received and frictionally retained by a corresponding well on the opposite element, thereby locating and securing the cover to the tray, and also locating and securing the central support panel between the tray and the cover.

U.S. Pat. No. 6,533,133, Liu, discloses a test tube rack including a top tray with legs or rods for bridged placement over a lower tray set and through holes disposed on a flexible sandwich plate on the upper portion of the bottom tray set.

U.S. Pat. No. 5,133,939 to Mahe, shows a test tube holder having a top shelf comprising a rigid first plate with a plurality of holes for test tubes, and a second flexible sheet having a second plurality of holes slightly smaller than, but in vertical alignment with, the holes in the rigid first plate, such that a frictional engagement is provided of sufficient force so as to maintain the test tubes at any desired position. A bottom shelf is spaced apart from and secure to the top shelf.

U.S. Pat. No. 5,080,232 to Leoncavallo, et al, discloses a test tube rack and retainer with a projecting member for firmly holding in position a test tube or similar article placed in the rack.

U.S. Pat. No. 6,640,981 to Lafond, et al, a stackable modular test tube rack comprising a flat rectangular body with a series of wells for receiving tubes. A pair of handles vertically extend at opposite end walls of the body, and each handle has a lower portion that includes a hand gripping upper portion and has a bottom edge configured to anchor with the top edge of the handle of an underposed similarly constructed rack to enable stacking.

U.S. Pat. No. 6,019,225 to Kalmakis, et al, shows a pipette tip support rack having a honeycomb structure. The rack includes an array of interconnected sleeves, each constructed to support a pipette tip. The sleeves are connected by bridges which form along abutting, touching surfaces or which extend between non-touching sleeves. Openings are formed between adjacent ones of said sleeve which occupy substantially all of the space between adjacent sleeves not occupied by the bridges. Inwardly extending lips on the interior of each sleeve support the enlarged portion of the pipette tip and provide a channel through which the stem extends. Interior side walls of each sleeve provide lateral support to the pipette tips. The tray is used in conjunction with a container but does not provide means for stacking trays.

The foregoing patents reflect the current state of the art of which the present inventors are aware. Reference to, and discussion of, these patents is intended to aid in discharging Applicants' acknowledged duties of candor in disclosing information that may be relevant to the examination of claims to the present invention. However, it is respectfully submitted that none of the above-indicated patents disclose, teach, suggest, show, or otherwise render obvious, either singly or when considered in combination, the invention described and claimed herein. Notably, size does make a difference in the relevant art, and none of the analogous apparatus, while structurally similar, provide the advantages offered by the present invention in the field of plant propagation.

### BRIEF SUMMARY OF THE INVENTION

The present invention is a container array rack for holding a large number of plant starter cells. The rack holds starter cells as discrete units whereby cell-to-cell cross-contamination is greatly minimized. The receptacles or sockets for holding tubular plant starter cells are joined structurally, but include significant air space between the sockets, and this facilitates for air circulation and water drainage also offers excellent isolation of media-containing cells. This feature has significant benefits in certain settings, such as in nematology research conducted in a lab or greenhouse environment.

It is a first and principal object of the present invention to provide a new and improved container array rack that has removable and height-adjustable legs.

It is another object of the present invention to provide a new and improved container array rack having legs fabricated from inexpensive and readily available plastic pipe.

It is yet another object of the present invention to provide a plant starter cell container rack that may be adjustably stacked vertically with other such racks at a vertical distance sufficient to allow for light exposure to all plants in lower racks and for unimpeded early plant growth.

It is still another object of the present invention to provide a container array rack that tightly nests with other racks for storage and shipping with the legs are removed.

Another object of the present invention is to provide a container array rack having legs disposed interiorly from the edge of the rack, facilitating easy handling.

Yet another object of the present invention is to provide a plaint cell container array rack having open areas between the cell holding rings for air circulation and fluid drainage.

A further object of the present invention is to provide a container array rack having tapered openings for holding similarly tapered plant starter cells. This provides for snug holding of the cells for secure and easy handling.

A still further object of the present invention is to provide a plant starter cell container array rack having means for stacking numerous levels of racks.

Other novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration and description only and are not intended as a definition of the limits of the invention. The various features of novelty that characterize the invention shall be set out with particularity in the claims to be filed in a non-provisional patent application claiming the benefit of the filing date of the instant application. The invention does not reside in any one of these features taken alone, but rather in the particular combination of all of its structures for the functions specified.

There has thus been broadly outlined the more important features of the invention in order that the detailed description thereof that follows may be better understood, and in order that the present contribution to the art may be better appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important, therefore, that the specification be regarded as including such equivalent constructions insofar as they do not depart from the spirit and scope of the present invention.

### BRIEF DESCRIPTION OF THE SEVERAL VIEWS OF THE DRAWINGS

The invention will be better understood and objects other than those set forth above will become apparent when consideration is given to the following detailed description thereof. Such description makes reference to the annexed drawings wherein:

FIG. 1 is an upper perspective view of a 25-cell embodiment of the plant starter cell container array rack of the present invention, showing the rack entirely filled with starter cells;

FIG. 2 is a top plan view thereof, and

FIG. 3 is a perspective view showing stacked container array racks of the present invention.

### DETAILED DESCRIPTION OF THE INVENTION

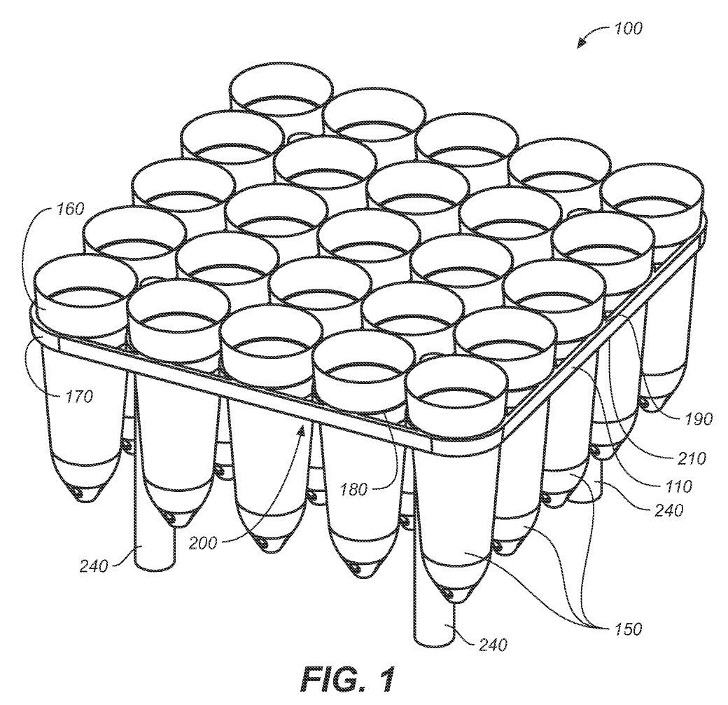

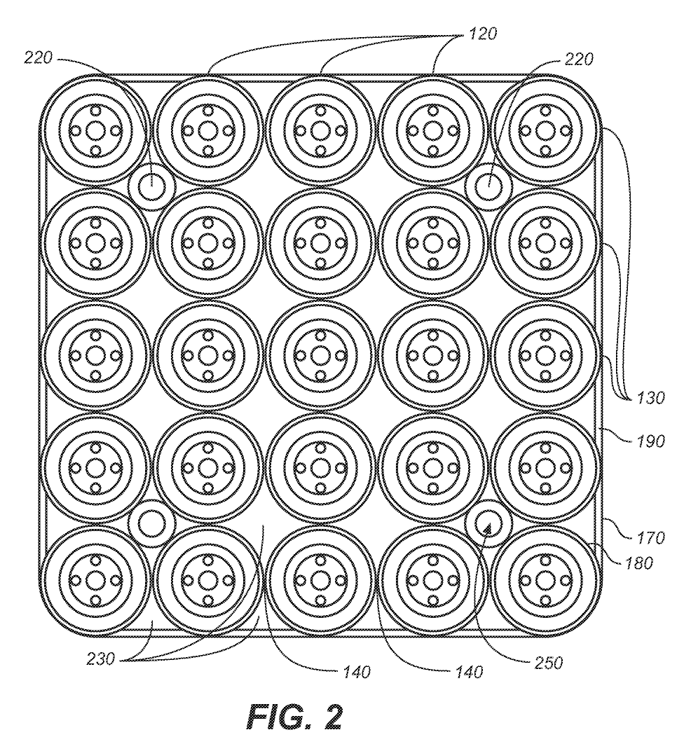

Referring to FIGS. 1 through 3, wherein like reference numerals refer to like components in the various views, there is illustrated therein a new and improved plant starter cell container array rack, generally denominated 100 herein.

These views show that in a first preferred embodiment the inventive apparatus comprises a generally planar, rigid, injection-molded plastic plant tray 110 designed to securely contain and hold 25 individual plastic plant starter cells for starting plant growth. Accordingly, the plant starter cells will typically soil media and plants. The plant tray includes a grid 120 of starter cell sockets 130. Each of the sockets is a substantially circular ring which is connected to adjoining starter cell sockets by tangential points of contact 140. The grid of starter cell sockets includes a plurality of vertical and horizontal rows in any desired number. The starter cell sockets preferably measure 2½″ in diameter at their upper edges to accept and capture industry standard plant starter cells 150 immediately under the cell collars 160 at the upper portions of the cells. The taper in the starter cell sockets ensures a snug fit for the correspondingly tapered cells.

This grid is circumscribed by an outside wall 170, preferably comprising a substantially square band of plastic measuring approximately 14″ on all four sides. The starter cell sockets at the grid corners define and form the corners of the tray. As will be appreciated, the shape of the tray may be any of a number of other suitable shapes, including rectangular, triangular, and multisided polygonal.

Preferred material dimensions of the tray include a ½″ outside wall, 1¼″ wide starter cell sockets having an upper edge 180 generally coplanar with the upper edge 190 of the outside wall and extending downwardly to terminate in a lower edge 200 which is approximately ½″ below the lower edge 210 of the outside wall.

The tray further includes four ¾″ diameter leg sockets 220 which project roughly ½″ above the plane formed by the upper edges of the starter cell sockets and outside wall. The leg sockets are sized to accept ¾″ PVC legs.

It should be noted that when the tray is filled with plant starter cells, there remain a plurality of air spaces 230 between the cells. These openings facilitate air movement from and light transmission through the top to the bottom of the tray even when the top is filled with cells and plants.

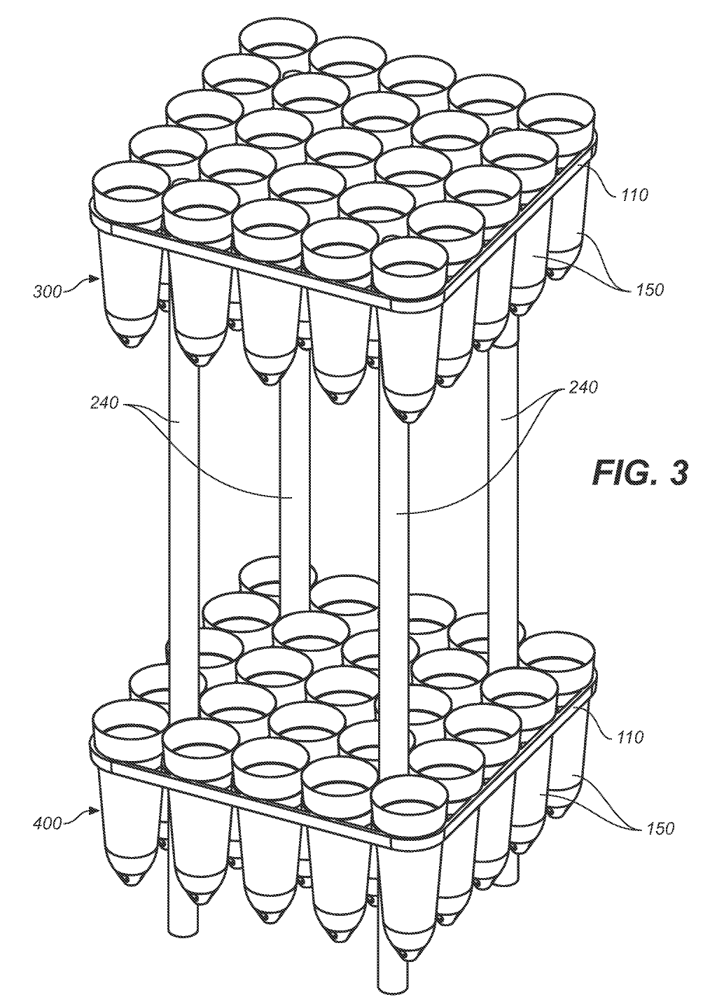

The inventive container array rack further includes removable legs 240. As noted, the tray includes leg sockets specially sized to accommodate four legs constructed from standard schedule 40 ¾″ PVC pipe. The sockets preferably have an outside diameter of 1¼″ and an inside diameter of ¾″. The sockets extend ½″ below the lower edge of the outside wall and include ¾″ plastic plugs 250 extending ½″ above the upper edges of the starter cell sockets and the outside wall. The plug is a male element that fits snuggly into the open end (female element) of a leg configured as a pipe. Thus, the upper surface of the plant tray includes means to securely place a leg for stacking plant trays above. The portion of the leg socket extending below the plant tray simply accepts and captures a leg by its outside diameter, and does not include a plug for insertion into the opening in the leg. Thus, for instance, and referring now to FIG. 3, if the legs comprise cut lengths of standard schedule 40 PVC pipe, the legs can be interposed between an upper plant tray 300 and a lower plant tray 400 simply by inserting legs into the leg socket openings in the bottom of tray 300 and onto the leg socket plugs of the lower tray 400.

As will be readily appreciated, the leg sockets may be either male or female in conformation, or any combination thereof, when used in connection with hollow pipe, inasmuch as the outer circumference can of the pipe engage a female leg socket (i.e., the female leg socket can receive and capture the pipe with a friction fit), and the inside wall of the pipe can engage a male plug element (i.e., the inside wall of the pipe can receive and capture the male element). Accordingly, both configurations, and combinations thereof, are contemplated in the present invention.

According to such a construction, legs of any length may be cut from standard plastic plumbing pipe, such as readily available schedule 40 PVC pipe. This allows the end user to customize the height of the tray for different kinds of plants and growth periods. When rapidly growing upright plants are started in the starter cells, the legs can be sized to accommodate the anticipated vertical growth. Likewise, if low growing and shade loving ground cover is started in the starter cells, the legs can be considerably shortened.

Furthermore, the legs can be easily removed for stacking when the trays are empty. To add to stability when stacking trays, the leg sockets are disposed proximate each corner in the space between the first and second rows of starter cell sockets as viewed from all of the adjacent sides of the outside wall of the tray. This placement also facilitates easy handling of the trays and to prevent the trays from being knocked about at the legs.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

What is claimed as invention is:

1. A plant starter cell container array rack, comprising:
at least one generally planar plant tray having a plurality of starter cell sockets for holding plant starter cells;
a plurality of leg sockets, each adapted to accept an end of a support leg; and
a plurality of legs, each having an end removably inserted into one of said leg sockets.

2. The plant starter cell container array rack of claim 1, wherein said plant tray comprises a grid of starter cell sockets, each of said starter cell sockets having an upper edge forming a plane, and a lower edge.

3. The plant starter cell container array rack of claim 2, wherein said leg sockets project above the plane formed by said upper edges of said starter cell sockets.

4. The plant starter cell container array rack of claim 2, further including an outside wall substantially surrounding said grid of said starter cell sockets, said outside wall having an upper edge and a lower edge.

5. The plant starter cell container array rack of claim 4, wherein said leg sockets extend below said lower edge of said outside wall and further include plugs extending above said upper edges of said starter cell sockets and said upper edge of said outside wall, said plugs adapted for insertion into an open end of a tubular leg.

6. The plant starter cell container array rack of claim 1, wherein each of said starter cell sockets taper inwardly from said upper edge to said lower edge.

7. The plant starter cell container array rack of claim 6, wherein adjacent starter cell sockets are connected by tangential points of contact.

8. The plant starter cell container array rack of claim 1, wherein said starter cell sockets form a grid having a plurality of horizontal and vertical rows which form corners, and wherein said plant tray leg sockets are disposed proximate each corner in the space between the first and second rows of starter cell sockets from each of every two adjoining sides of said outside wall of said plant tray.

9. The plant starter cell container array rack of claim 1, wherein said starter cell sockets have an upper edge and a lower edge, and an outside wall surrounding said starter cell sockets and having an upper edge and a lower edge, and wherein said upper edge of said starter cell sockets is generally coplanar with said upper edge of said outside wall and said lower edge of said starter cell sockets extends below said lower edge of said outside wall.

10. A set of stackable plant starter cell trays, comprising:
a plurality of plant trays having starter cell sockets for removable insertion of plant starter cells, each of said plant trays having upper and lower leg connection means for the removable insertion of support legs; and
a plurality of support legs, one each removably inserted into one of said leg connection means.

11. The apparatus of claim 10, wherein said leg sockets comprise female openings for receiving a pipe inserted therein.

12. The apparatus of claim 10, wherein said legs comprise hollow pipe, wherein said leg sockets include a male element for insertion into one of said hollow pipes, and wherein each of said hollow pipes captures and retains one of said male elements of said leg sockets.

13. The apparatus of claim 10, wherein said leg sockets comprise female elements for receiving and capturing said legs with a friction fit.

14. The apparatus of claim 10, wherein said starter cell sockets form a grid of substantially circular rings surrounded by an outside wall, wherein adjoining starter cell sockets are connected at tangent points, and wherein at places other than tangent points, the spaces between starter cell sockets and said outside wall is open air space which facilitate air movement from and light transmission through said plant tray even when said plant tray is filled with starter cells and planting material.
